(19) United States
(12) Patent Application Publication
(10) Pub. No.: US 2008/0275754 A1
(43) Pub. Date: Nov. 6, 2008

(54) SYSTEM FOR AUTOMATED MANAGEMENT OF A MIXED WORKFORCE USING PRIORITY QUEUING OF AUTOMATED BID DISPATCH AND COMPLIANCE MONITORING

(75) Inventor: Jackson Mugisa, Claymont, DE (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: ZURISOFT, LLC, Chadds Ford, PA (US)

(21) Appl. No.: 12/062,166

(22) Filed: Apr. 3, 2008

Related U.S. Application Data
(60) Provisional application No. 60/909,840, filed on Apr. 3, 2007.

(51) Int. Cl. G06Q 50/00

(52) U.S. Cl. 705/9

(57) ABSTRACT

A system for coordinating and monitoring laborers and their agents in and across organizations is provided which includes a database, a computing apparatus, and a first and second network. The database contains information regarding a staffing requirement, including a time period a labor is required and a minimum professional qualification for the labor, a staffing schedule including data on whether or not the staffing requirement is currently filled, and a sequence of preferences related to filling of the staffing requirement. The first network includes a first digital messaging pathway between the computing apparatus and a first potential laborer, and the second network including a second digital messaging pathway between said computing apparatus and an entity possessing the staffing requirement or an agent of the entity.

### CROSS-REFERENCE TO RELATED APPLICATION

This application claims the benefit of U.S. Provisional Application Ser. No. 60/909,840, filed Apr. 3, 2007, entitled System for Automated Management of a Mixed Workforce Using Priority Queuing of Automated Bid Dispatch and Compliance Monitoring.

### BACKGROUND OF THE INVENTION

This invention relates generally to automated staff scheduling systems, and more particularly to automating the processes of selecting and contacting staff to build shift schedules, as well as monitoring staff compliance in the execution of scheduled work.

Today, complex organizations rely upon a variety sources for their workforces. These sources include internal permanent and temporary employees, plus external contract employees, consultants, and day workers. Often the coordination of these disparate resources requires a great deal of manual labor and direct personal communication. Despite often elaborate internal automated scheduling systems, large employers are often reduced to using elementary means, such as teleconferences, emails, and facsimile transmissions. This is due to a variety of factors, including the variety of systems used by the various internal divisions and outside partners, as well as time pressures and quality and regulatory compliance complexities. The result too often is substantial scheduling delays and uncertainties. Where staffing levels or qualifications are critical, this may result in large overtime costs or potential liabilities.

Of particular concern is the inefficiency these challenges lead to in the healthcare industry where the level of care, and indeed lives, may depend upon proper staffing of facilities at all times. In the short term, it is critical that the proper number of workers with the appropriate professional credentials be available to assist patients. In the long term, it is also of great interest that this staffing occur at the most efficient pricing.

These issues are not limited to healthcare. Similar difficulties may be seen in any number of other industries, such as passenger transportation, cargo logistics, education, and even the performing arts, among others.

### BRIEF SUMMARY OF THE INVENTION

The present invention is directed to a system for automatically coordinating and monitoring laborers and their agents in and across organizations by means of a database containing information regarding staffing requirements, staffing schedules, and a sequence of preferences for the filling of the staffing requirements. A computing apparatus uses the sequence of preferences to contact each potential laborer or labor agent in turn. Information regarding the current status of a staffing schedule is available to the entity possessing the staffing requirement. Optionally, performance data on actual work performed is collected. Such data may be used separately or in combination with data about historical responses to scheduling solicitations to alter the preference sequence of laborers or labor agents in future schedule building efforts.

Specifically, a preferred embodiment of the present invention is directed to a system for coordinating and monitoring laborers and their agents in and across organizations is provided which includes a database, a computing apparatus, and a first and second network. The database contains information regarding a staffing requirement, including a time period a labor is required and a minimum professional qualification for the labor, a staffing schedule including data on whether or not the staffing requirement is currently filled, and a sequence of preferences related to filling of the staffing requirement. The first network includes a first digital messaging pathway between the computing apparatus and a first potential laborer, and the second network including a second digital messaging pathway between said computing apparatus and an entity possessing the staffing requirement or an agent of the entity.

The computing apparatus may be adapted to select the first potential laborer in accordance with the sequence of preferences for the filling of the staffing requirement. The computing apparatus may dispatch information through the first digital messaging path regarding an unfilled staffing requirement to the first potential laborer or agent of the first potential laborer. The computing apparatus may be arranged to receive digital messaging through the first digital messaging pathway from the potential laborer or agent of the potential laborer. The computing apparatus may be further arranged to set a database entry for the staffing requirement as filled in a case of a positive response from the potential laborer or agent of the potential laborer. In a case of a negative response from the first potential laborer or agent of first the potential laborer, the computing apparatus is further arranged to dispatch new digital messaging regarding the unfilled staffing requirement to a less preferred second potential laborer or agent of the second potential laborer in accordance with a sequence of preferences for the filling of the staffing requirement. The computing apparatus may be further arranged to dispatch new digital messaging regarding the unfilled staffing requirement to a less preferred second potential laborer or agent of the second potential laborer in accordance with a sequence of preferences for the filling of the staffing requirement in default of a response from the first potential laborer or agent of the first potential laborer.

The computing apparatus may be further arranged to create a database record of a response of the first potential laborer which includes whether the response was positive or negative and how timely the response was. The computing apparatus may be arranged to automatically adjust the sequence of preferences for the filling of the staffing requirement based at least in part upon a how timely a response was. The computing apparatus may be arranged to automatically adjust the sequence of preferences for the filling of the staffing requirement based at least in part upon whether a response was positive or negative.

Preference or other compensation may be awarded to a potential laborer or agent of a potential laborer based at least in part upon timely positive responses to the digital messaging. Preference or other compensation may be awarded to a potential laborer or agent of a potential laborer based at least in part upon timely negative responses to the digital messaging.

The computing apparatus may further be arranged to receive digital messaging from the entity possessing the staffing requirement containing a record of work performed. The record of work may include information about the laborer, wherein the information is may include the amount of work performed, the timeliness of work performed, and the quality of work performed.

The computing apparatus may be arranged to provide preference or other compensation to the laborer based at least in part upon the record of work performed. The computing apparatus may be arranged to provide preference or other compensation to a third potential laborer or agent of the third potential laborer based at least in part upon the record of work performed.

The system may further comprising a network including a third digital messaging pathway between the computing apparatus and a staffing compliance monitoring entity, whereby the staffing compliance monitoring entity may access a staffing level database record of either or both a previously achieved staffing level or a currently scheduled staffing levels. The staffing level database record may include a number of laborers relative to a situational requirement. The situational requirements may include caregiver to patient ratios in a healthcare setting.

The computing apparatus may further be arranged to provide budgetary impact projections of current staff scheduling. The computing apparatus may further be arranged to provide reports of the performance of a laborer or the agent of a laborer. The computing apparatus may further be arranged to provide reports of the performance of a potential laborer or the agent of a potential laborer. The computing apparatus may further be arranged to provide training materials or notification of new training materials or requirements to selected users. The computing apparatus may further be arranged to collect data related establishing the receipt of training materials by selected users. Finally, the computing apparatus may further be arranged to collect data demonstrating the exposure of users to the content of training materials.

### BRIEF DESCRIPTION OF THE SEVERAL VIEWS OF THE DRAWINGS

The invention will be described in conjunction with the following drawings in which like reference numerals designate like elements and wherein:

FIG. 1 is a schematic diagram of a computing apparatus and its connection by various messaging pathways to employers and employer agents, laborers and labor agents, and regulatory entities in a given labor market in accordance with a preferred embodiment of the present invention;

FIG. 2 is a schematic diagram depicting the flow of various data items various parties depicted in FIG. 1;

FIG. 3 is a schematic diagram of an exemplary embodiment of the invention as used for the exemplary task of automating the labor search and scheduling process of a healthcare provider;

FIG. 4 is a schematic diagram of an exemplary process of interaction experienced by an agent of the healthcare provider of the example depicted in FIG. 3; and

FIG. 5 is a schematic diagram of the interaction of processes in an exemplary embodiment of the invention which includes the core bid sequencing process. In this embodiment, there is an associated feedback process which utilizes information about the manner in which bid receivers responded to these bids. There is a further feedback process regarding the quality of work performed vis-à-vis the agreed schedule.

### DETAILED DESCRIPTION OF PREFERRED EMBODIMENTS OF THE INVENTION

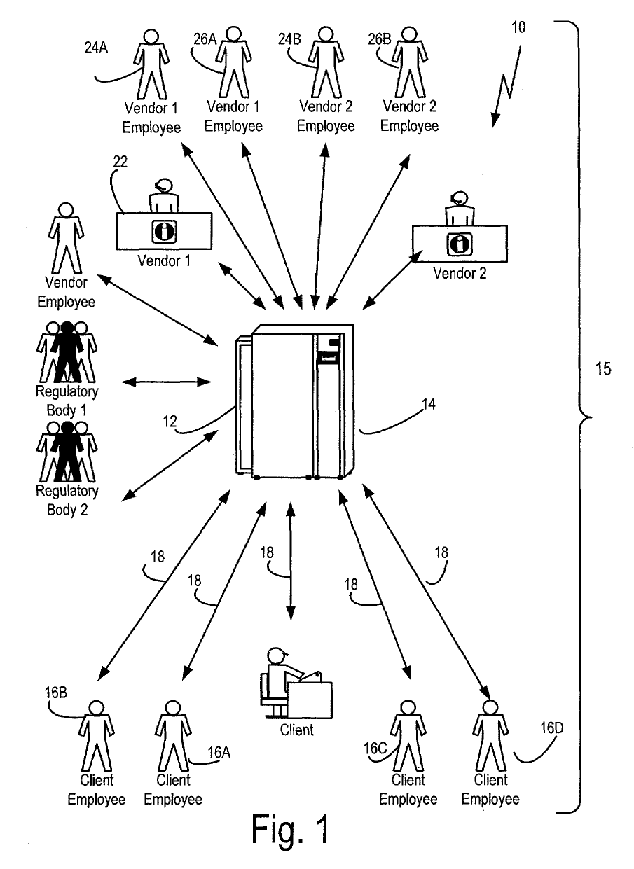

Referring to FIG. 1, in a first preferred embodiment of the present invention, the invention comprises a system for coordinating and monitoring laborers and their agents in and across organizations 10. The system 10 includes a database 12 containing information regarding staffing requirements, including: a period of time labor is required and a minimum professional qualification for performance of the labor; a staffing schedule, including data on whether or not the staffing requirement is currently filled; and a sequence of preferences for the filling of the staffing requirement. A sequence of preferences is an ordering of priority for contacting potential laborers or labor agents while filling a staffing schedule. Priority may be given to certain parties due to factors such as seniority, hourly billing rates, contractual obligations, etc. Herein the digital messaging alerting a party of the opportunity to be included in a particular staffing schedule may be referred to as a bid. The collection of parties that receive bids simultaneously, if such occurs, may be referred to as a bid tier. The sequence of preferences for the filling of the staffing requirement will normally include how long the system should delay before sending bids to a second bid tier in default of a response from a party in the first bid tier. The invention 10 also includes a computing apparatus 14 and a network 15 including a digital messaging pathway 18 between the computing apparatus 14 and potential laborers or their agents 16A, 16B, 16C, 16D. Non-limiting examples of digital messaging pathways 18 include automated telephony messages and touch-tone response, two-way pagers, cellular phone instant messaging, email, electronic data exchanges, Internet file transfer and web servers, and the like. Similarly the system 10 includes a network including a digital messaging pathway 20 between the computing apparatus 14 and an entity possessing the staffing requirement 22 or an agent of the entity.

In a further embodiment of the invention 10 the computing apparatus 14 uses the sequence of preferences to select which potential laborer 16A, 16B, 16C, 16D or agent will receive notification of a schedule opening. If the first one asked responds in the affirmative, then that one is assigned to the schedule. If the first one responds negatively, or if the first one fails to respond in a timely fashion, the system will select and contact the next, less preferred, laborer or agent. This process repeats until the schedule is filled.

Significantly, a bid tier may include any number of laborers or labor agents. For example, one individual may be given first preference, then a department of workers given second preference, the third preference to a different individual, and then fourth preference be given to all temporary staffing agencies at once. This enables, among other things, the ability to accommodate contractual or statutory requirements for preference or equality of opportunity.

Significantly, a bid tier may be restricted to persons possessing specific minimum professional qualifications, non-limiting examples of which include certifications, licenses, bonding, insurance, or the like. This is in addition to restriction of a job shift to laborers of a certain minimum professional qualification. For example, in a healthcare setting, a position may be restricted to a registered nurse (RN), but the first preference could be given to a more qualified candidate who is a nurse practitioner (NP).

This automated queuing of potential laborers is very significant for two reasons. The first is the inefficiency of current typical practices. With disparate computing resources scattered among institutions, communication pathways are often antiquated and typically require a high human involvement. This leads to wasted labor and, too frequently, critical delays in responding to changes in demand due to circumstance or contingencies. In the case of a healthcare market, crises, transit accidents, and illness of workers can all leave institutions critically short handed. As a result, institutions are normally forced to rely on overtime extensions of shifts of workers already on hand. This means that tired, overworked care providers are giving lower quality efforts at higher rates of pay. Thus, rapid automated filling of staffing schedules is extremely beneficial to institutions trying to gain timely access to fresh and cost effective resources.

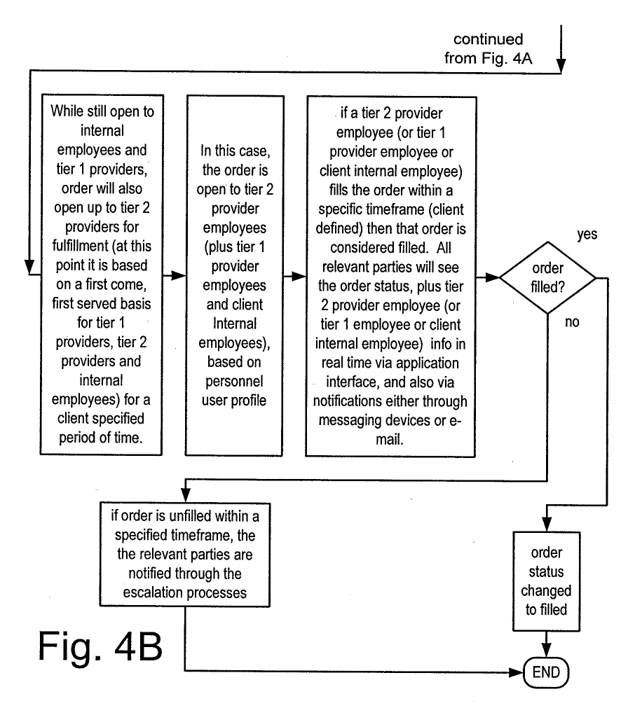

The automation of dispatching staffing schedule bids, dispatch and recording responses from potential laborers or labor agents provides an additional opportunity for a system that adjusts itself in accordance with the peculiar histories of the members of the labor pool. In a further embodiment of the invention, the computing apparatus is further arranged to create a database record of the kind (positive or negative) and timeliness of response of each laborer or agent. See FIG. 5. This information can then be reviewed manually or, in a further embodiment of the invention, the computing apparatus 14 may be arranged to automatically adjust the sequence of preferences for the filling of the staffing requirement based at least in part upon historical records of either the kind or timeliness of responses from each potential laborer or agent of each potential laborer. Preference for contact for shift openings is just one of many possible rewards. Laborers may receive cash or other incentives for quick responses which aid the system in rapidly reaching desired resources.

It is significant that this may include preference or other compensation being awarded for both positive and negative responses. A quick no is better than a slow response, or no response whatsoever.

A network 15 constructed to provide two-way dialogue about schedule openings may be further exploited in a number of ways. In a further embodiment of the invention, work record data, i.e., records of actual work done, may be collected, to include information about the laborer or the agent of the laborer 16A, 16B, 16C, 16D, and some other aspect such as the amount of work performed, the timeliness of work performed, or the quality of work performed. Such data is of extreme importance for financial operations such as accounts payable and account receivable, budgets and forecasting, and billings and payments to various entities.

Such data is also paramount in optimizing the schedule opening dispatch process. Laborers 16A, 16B, 16C, 16D who are chronically late or otherwise underperforming should receive lower preference in the scheduling process. Conversely, high performances for particular tasks should receive top preference. Therefore, in a further embodiment of the invention, the computing apparatus is arranged to provide preference or other compensation to the laborer or labor agent 16A, 16B, 16C, 16D based at least in part upon the record of work performed.

Similarly, such accounting visibility enables greater accountability and alignment of interests. For example, the presence of work record data in the schedule dispatch system would allow laborers 16A, 16B, 16C, 16D to received fair hourly compensation for referrals of new laborers to the network. For example, in some systems, a laborer 16A, 16B, 16C, 16D may receive a commission of $0.50 per hour for the work done by a newly referred laborer. Current accounting systems do not allow easy sharing of such data, and therefore cannot be counted upon to provide proper accounting of, therefore proper encouragement of, referrals of this kind. Thus, in a further embodiment of the invention, the computing apparatus is arranged to provide preference or other compensation to a third party base at least in part upon the work records of a given laborer.

Today, compliance agencies struggle to acquire and audit data related to staffing requirements retrospectively. Even last week's or even last month's activities may not be available to a compliance agency for audit or analysis. The present invention, however, by providing a consolidated platform of live data of the scheduling process, could allow compliance monitors access to current data not simply about respective staffing levels, but also the status of current shifts, and all currently known data about prospective labor shifts. Such data could be available in real time, which for present purposes would mean information refreshed several times per hour, and potentially up-to-the-minute or even more often. Therefore, in a further embodiment of the invention, the system 10 further comprises a network 15 including a digital messaging pathway 22 between the computing apparatus and a staffing compliance monitoring entity whereby the staffing compliance monitoring entity may access a staffing level database record of either or both a previously achieved staffing level or a currently scheduled staffing levels. Such information might include also the number of laborers relative to a situational requirement. For example, in a healthcare setting, the data could include the number of patients in a given ward or the patient to caregiver ratios. Further indicators could include the credential level of those care givers, and the matching of those credential levels to target levels for individuals and for the mixtures among a group assigned together in working shift. Central management and filtration of laborers on the basis of both registered qualifications and prior supervisory satisfaction will help to insure the quality of staff assigned to fill specific requirements. Non-limiting examples of compliance agencies in the U.S.: healthcare industry include the Joint Committee on Accreditation of Healthcare Organizations (JHACO), Medicare, and Medicaid, or internal organizations which monitor compliance with such entities.

The up-to-the-minute currency of the system provides novel visibility to the staffing schedule filling process. Further, it provides an opportunity for unprecedented oversight and control of the process. Agents of the entity possessing the staffing requirement can alter or cancel that requirement at any time. Similarly, the digital messaging pathways allow other users to similarly alter data. For example, labor agents could inform entities possessing staffing requirements of newly available laborers or new professional qualification certifications of laborers. The system can be adapted to generate automatic notifications or undertake automatic remedial actions as trigger levels are reached. Examples in a healthcare context could include an automatic notification being sent to a regulatory agency when projected staffing levels are running critically low, or automatically contacting additional laborers to fill shifts as unexpectedly high hospital patient census data is received. In the latter case, the process of filling the staff shortage may be underway, or even complete, before the affected wards are aware of the pending shortage.

A myriad of accounting reports may be provided from the data collected by the system 10. Non-limiting examples of these include reports on the performance of a laborer, 16A, 16B, 16C, 16D a labor agent, a staffing budget, or of meeting a staffing regulatory requirement. Such reports may be available on retrospective data, up-to-the-minute current data, or up-to-the-minute condition of prospective data. Hence in a further embodiment of the invention, the computing apparatus is further arranged to provide budgetary impact projections of current staff scheduling, reports of the performance of a laborer or the agent of a laborer, and reports of the performance of a potential laborer or the agent of a potential laborer. The latter may contain data related to performance in regard to the timeliness of response to bid offers. By maintaining both reference budgetary figures and timely data of actually needs and staffing results, the system is capable of providing both variance reporting and, if desired, timely automatic notifications of variances in desired financial, quality, or compliance aspects of work scheduled or performed.

Routine use of the system for rapid filling of staff requirements creates a variety of benefits for all users. For example, the system can be arranged to allow regular direct employees scheduled to work in shift rotations to place or accept bids to swop shifts with other laborers. All laborers could be enabled to record preferences for availability to work. If availability to work changes quickly, the system can respond in near-real time. For example, if a worker suddenly becomes available to work, a current list of opportunities can be displayed.

Routine use of the system will create a social network of users that can be exploited in a number of ways. A non-limiting example of expanded uses of the social network include the dispatch of non-work event opportunities such volunteer labor functions or fundraising events. Such events tend to serve to build a sense of community among workers in such a network while serving broader public needs. Similarly, the system may be utilized to dispatch significant announcements. Further, the system may be used to dispatch and monitor compliance of the reading and understanding of training materials.

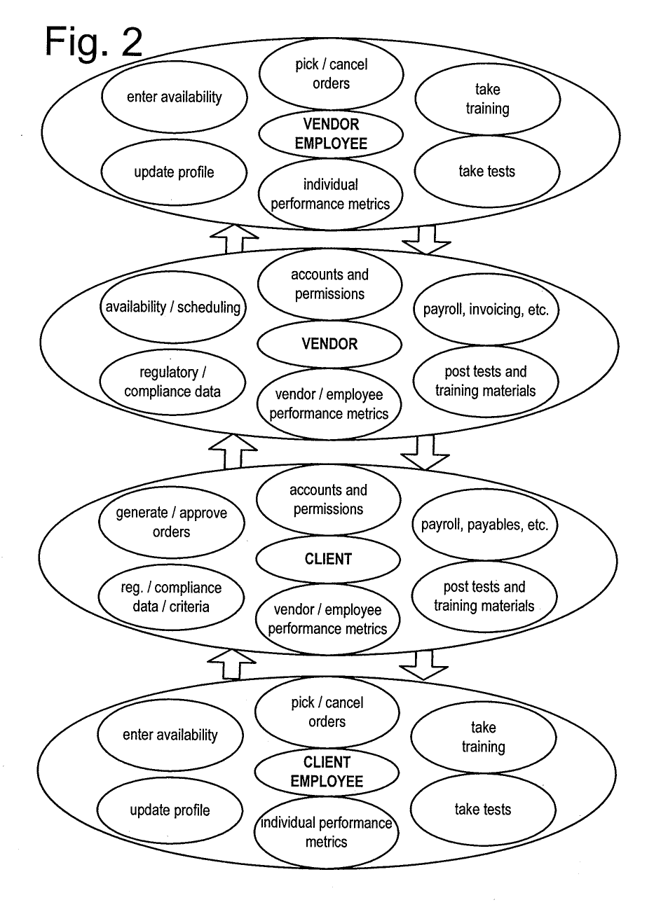

A system comprising the subject matter invention may encompass a plurality of features tailored to address the varying needs of the multiple users. Referring to FIG. 2, four groups of application processes are shown for four typical kinds of users: a vendor employee, a vendor, a client, and a client employee. The employees have similar needs. However, due to the differences in their relationships to the client entity, the options available to them and the mode of the transaction with the system may vary greatly. Similarly, the client and the vendor to that client, while possessing analogous requirements for the management of their respective staffs, may have widely disparate needs for the detailed implementation of solutions for those requirements. Significantly, however, it is conceived that common data elements should be easily shared across the applications for all users, such that, for example, the results of testing to confirm training by vendor employee is automatically available to the schedule process of the client applications in order to verify the suitability of the vendor employee to fill a staffing requirement.

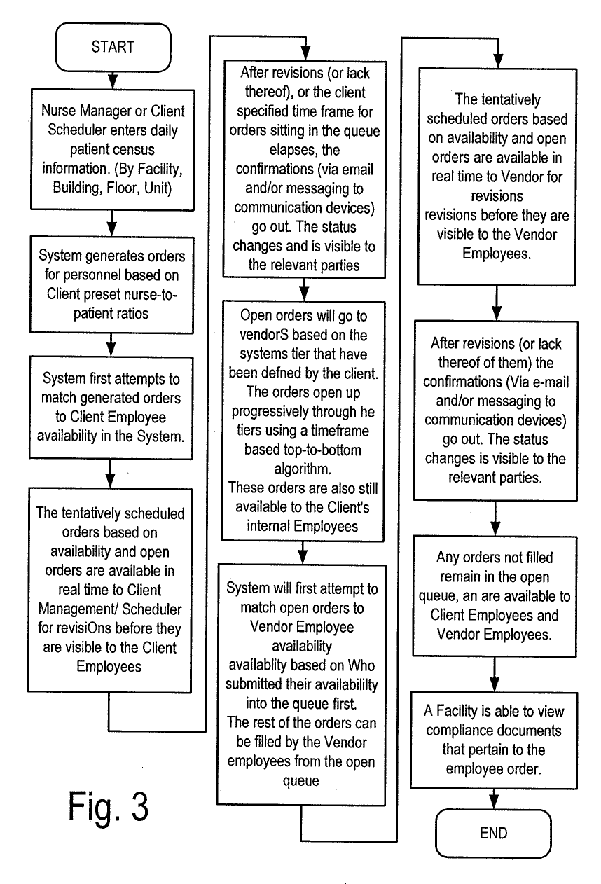

FIG. 3 is a schematic diagram of an exemplary embodiment of the invention as used for the exemplary task of automating the labor search and scheduling process of a healthcare provider. Here the process is depicted in a linear fashion.

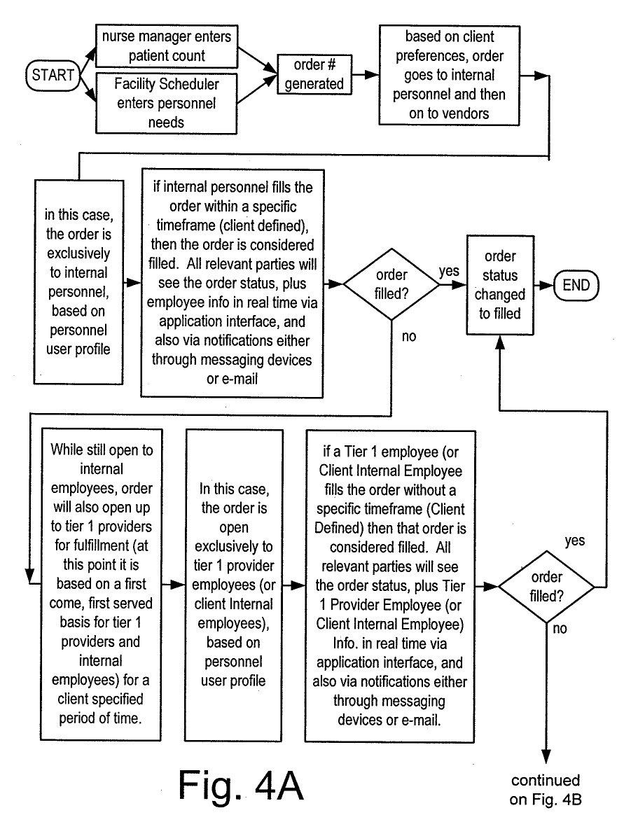

In contrast, FIG. 4 is a schematic diagram of an exemplary process of interaction experienced by an agent of the healthcare provider of the example depicted in FIG. 3. Note the use of hierarchical tiers to fill staffing requirements according to the policies and preferences of the client.

FIG. 5 is a schematic diagram of the interaction of processes in an exemplary embodiment of the invention which includes the core bid sequencing process. In this embodiment, there is an associated feedback process which utilizes information about the manner in which bid receivers responded to these bids. There is a further feedback process regarding the quality of work performed vis-a-vis the agreed schedule. The subject matter invention may be achieved by a variety of computational mechanisms, of which FIG. 5 represents only a single example.

For the purpose of the present invention, wherever the term “agent” is used in association with a particular entity or person, the use of that particular entity or person is intended to include agents of that entity or person. For example, for the present system for coordinating and monitoring laborers, the term “laborers” is intended to be construed as “laborers and their agents.”

While the invention has been described in detail and with reference to specific embodiments thereof, it will be apparent to one skilled in the art that various changes and modifications can be made therein without departing from the spirit and scope thereof.

1. A system for coordinating and monitoring laborers and their agents in and across organizations comprising:
(a) a database containing information regarding:
(i) a staffing requirement, including a time period a labor is required and a minimum professional qualification for said labor;
(ii) a staffing schedule, said schedule including data on whether or not the staffing requirement is currently filled; and
(iii) a sequence of preferences related to filling of said staffing requirement;
(b) a computing apparatus;
(c) a network including a first digital messaging pathway between said computing apparatus and a first potential laborer; and
(d) a network including a second digital messaging pathway between said computing apparatus and an entity possessing said staffing requirement or an agent of said entity.

2. The system of claim 1 wherein said computing apparatus is adapted to select said first potential laborer in accordance with said sequence of preferences for the filling of said staffing requirement, and wherein said computing apparatus dispatches information through said first digital messaging path regarding an unfilled staffing requirement to said first potential laborer or agent of said first potential laborer.

3. The system of claim 2 wherein said computing apparatus is arranged to receive digital messaging through said first digital messaging pathway from said potential laborer or agent of said potential laborer.

4. The system of claim 3 wherein said computing apparatus is further arranged to set a database entry for said staffing requirement as filled in a case of a positive response from said potential laborer or agent of said potential laborer.

5. The system of claim 3 wherein in a case of a negative response from said first potential laborer or agent of first said potential laborer, said computing apparatus is further arranged to dispatch new digital messaging regarding said unfilled staffing requirement to a less preferred second potential laborer or agent of said second potential laborer in accordance with a sequence of preferences for the filling of said staffing requirement.

6. The system of claim 3 wherein said computing apparatus is further arranged to dispatch new digital messaging regarding said unfilled staffing requirement to a less preferred second potential laborer or agent of said second potential laborer in accordance with a sequence of preferences for the filling of said staffing requirement in default of a response from said first potential laborer or agent of said first potential laborer.

7. The system of claim 3 wherein said computing apparatus is further arranged to create a database record of a response of said first potential laborer which includes whether the response was positive or negative and how timely the response was.

8 The system of claim 7 wherein the computing apparatus is arranged to automatically adjust said sequence of preferences for the filling of said staffing requirement based at least in part upon a how timely a response was.

9. The system of claim 7 wherein the computing apparatus is arranged to automatically adjust said sequence of preferences for the filling of said staffing requirement based at least in part upon whether a response was positive or negative.

10. The system of claim 7 wherein preference or other compensation is awarded to a potential laborer or agent of a potential laborer based at least in part upon timely positive responses to said digital messaging.

11. The system of claim 7 wherein preference or other compensation is awarded to a potential laborer or agent of a potential laborer based at least in part upon timely negative responses to said digital messaging.

12. The system of claim 2 wherein said computing apparatus is further arranged to receive digital messaging from said entity possessing said staffing requirement containing a record of work performed.

13. The system of claim 12 wherein the record of work includes information about the laborer, wherein said information is selected from the group consisting of: the amount of work performed, the timeliness of work performed, and the quality of work performed.

14. The system of claim 13 wherein the computing apparatus is arranged to provide preference or other compensation to said laborer based at least in part upon said record of work performed.

15. The system of claim 14 wherein the computing apparatus is arranged to provide preference or other compensation to a third potential laborer or agent of said third potential laborer based at least in part upon said record of work performed.

16. The system of claim 3 further comprising a network including a third digital messaging pathway between said computing apparatus and a staffing compliance monitoring entity whereby said staffing compliance monitoring entity may access a staffing level database record of either or both a previously achieved staffing level or a currently scheduled staffing levels.

17. The system of claim 16 wherein said staffing level database record includes a number of laborers relative to a situational requirement.

18. The system of claim 17 wherein said situational requirements includes caregiver to patient ratios in a healthcare setting.

19. The system of claim 3 wherein the computing apparatus is further arranged to provide budgetary impact projections of current staff scheduling.

20. The system of claim 13 wherein the computing apparatus is further arranged to provide reports of the performance of a laborer or the agent of a laborer.

21. The system of claim 13 wherein the computing apparatus is further arranged to provide reports of the performance of a potential laborer or the agent of a potential laborer.

22. The system of claim 3 wherein the computing apparatus is further arranged to provide training materials or notification of new training materials or requirements to selected users.

23. The system of claim 3 wherein the computing apparatus is further arranged to collect data related establishing the receipt of training materials by selected users.

24. The system of claim 3 wherein the computing apparatus is further arranged to collect data demonstrating the exposure of users to the content of training materials.
